(19) United States
(12) Patent Application Publication
(10) Pub. No.: US 2020/0390065 A1
(43) Pub. Date: Dec. 17, 2020

(54) TWO-IN-ONE CONSTRUCTION FOR PET TOYS

(71) Applicant: PetSmart Home Office, Inc., Phoenix, AZ (US)

(72) Inventors: Toby Hannah Seadler, Scottsdale, AZ (US); Lisa Beilke, Peoria, AZ (US)

(21) Appl. No.: 16/868,921

(22) Filed: May 7, 2020

Related U.S. Application Data
(60) Provisional application No. 62/860,903, filed on Jun. 13, 2019.

(51) Int. Cl. A01K 15/02

(52) U.S. Cl. CPC A01K 15/026

(57) ABSTRACT

A pet toy assembly and method of forming such, the pet toy assembly including a first toy part, wherein the first toy part includes a cavity formed therein, as well as a second toy part separate from the first toy part. The second toy part is at least partially retained within the cavity of the first toy part prior to use of the pet toy assembly. Additionally, at least a portion of the second toy part extends from the first toy part prior to use of the pet toy assembly.

### CROSS-REFERENCE TO RELATED APPLICATIONS

This patent document claims priority to U.S. Provisional Patent Application No. 62/860,903, filed Jun. 13, 2019. The disclosure of the priority application is fully incorporated by reference.

### BACKGROUND

The present disclosure relates generally to pet toys and, more particularly, to two-in-one pet toys having an outer toy and an inner toy, wherein the inner toy is at least partially and temporarily retained within the outer toy.

Many pets (and pet owners) enjoy play toys of various shapes, sizes, and configurations. For example, pet owners may choose from, e.g., stuffing-filled plush toys of many different shapes and sizes, rope toys, ball toys, thermoplastic rubber (TPR) toys, consumables (e.g., chew toys, rawhide), etc. However, these various toy configurations are generally purchased and used individually, requiring the owners to buy and store each type of toy that may be to their pet's liking. Additionally, most existing pet toys provide little in the way of a challenge or surprise element, which again may be enjoyable by both the pets and their owners.

Accordingly, this patent document describes pet toy configurations that are intended to address the issues discussed above and/or other issues.

### SUMMARY

In accordance with one aspect of the disclosure, a pet toy assembly is disclosed. The pet toy assembly includes a first toy part, wherein the first toy part includes a cavity formed therein. The pet toy assembly may also include a second toy part separate from the first toy part, wherein the second toy part is at least partially retained within the cavity of the first toy part prior to use of the pet toy assembly. Additionally, and at least a portion of the second toy part may extend from the first toy part prior to use of the pet toy assembly.

According to another aspect of the disclosure, a pet toy assembly is disclosed, the pet toy assembly including an exterior toy part, wherein the exterior toy part includes a cavity formed therein. An interior toy part having an elongated portion and at least one secondary toy coupled thereto may also be included, wherein the interior toy part is separate from the exterior toy part and is partially and temporarily retained within the cavity of the exterior toy part. Furthermore, an end portion of the elongated portion of the interior toy part may extend from the exterior toy part.

In accordance with another aspect of the disclosure, a method of forming a two-in-one pet toy assembly is disclosed. The method includes providing exterior toy part, and forming a cavity within the exterior toy part. The method may also include forming at least one opening upon the exterior toy part, wherein the at least one opening communicates with the cavity, and providing an interior toy part separate from the exterior toy part, the interior toy part having an elongated portion and at least one secondary toy coupled thereto. The method may further include inserting a portion of the interior toy part into the cavity of the exterior toy part such that the at least one secondary toy coupled to the interior toy part is temporarily retained within the cavity and an end region of the elongated portion extends from the opening of the exterior toy part.

### BRIEF DESCRIPTION OF THE DRAWINGS

FIG. 1 is a top perspective view of a two-in-one pet toy configuration in accordance with an aspect of the disclosure;

FIG. 2 is a partial bottom view of the two-in-one pet toy configuration of FIG. 1;

FIG. 3 is a plan view of an interior toy of the two-in-one pet toy configuration of FIG. 1;

FIG. 4 is a front view of a two-in-one pet toy configuration in accordance with another aspect of the disclosure;

FIG. 5 is a top perspective view of the two-in-one pet toy configuration of FIG. 4; and

FIG. 6 is a plan view of an interior toy of the two-in-one pet toy configuration of FIG. 4.

### DETAILED DESCRIPTION

The following description is made for the purpose of illustrating the general principles of the present apparatus and is not meant to limit the inventive concepts claimed in this document. Further, particular features described in this document can be used in combination with other described features in each of the various possible combinations and permutations.

Unless otherwise specifically defined in this document, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to”. Additionally, use the term “couple”, “coupled”, or “coupled to” may imply that two or more elements may be directly connected or may be indirectly coupled through one or more intervening elements.

In this document, position-identifying terms such as “vertical”, “horizontal”, “front”, “rear”, “side”, “top”, and “bottom” are not intended to limit the invention to a particular direction or orientation, but instead are only intended to denote relative positions, or positions corresponding to directions shown when a pet toy or portion of a pet toy is oriented as shown in the Figures.

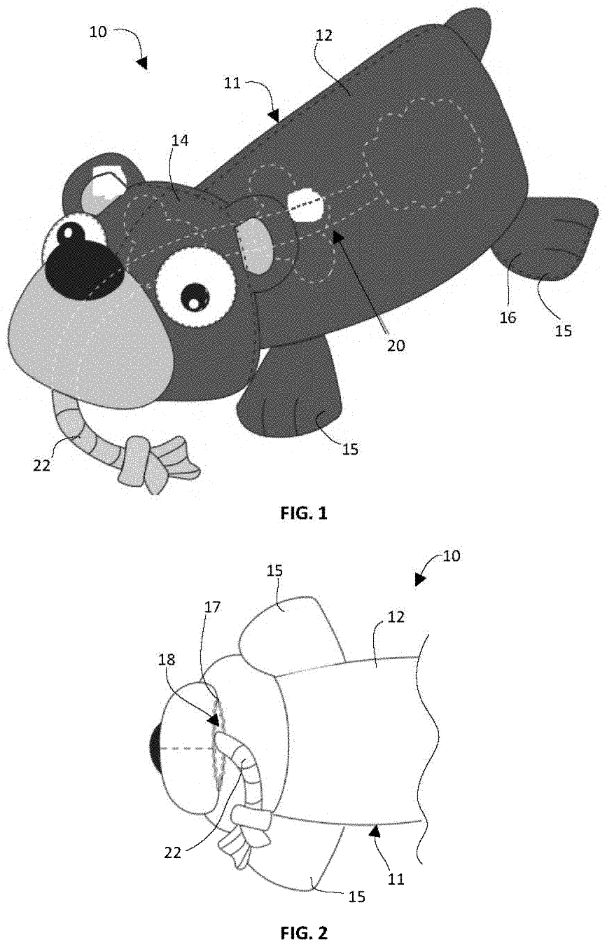

Referring to FIGS. 1-2, a two-in-one pet toy assembly 10 in accordance with an aspect of the disclosure is shown. In the configuration illustrated in FIGS. 1-2, a first toy part 11 of pet toy assembly 10 is in the shape of an animal (e.g., a bear) having a body portion 12, a head portion 14, a plurality of leg portions 15. Each leg portion 15 may house additional features such as, e.g., a squeaker 16, crinkle material, etc., which may add to the functionality and/or interest of the toy to the pet. Additionally and/or alternatively, other parts of the first toy part 11 of pet toy assembly 10 may house such additional “play” features. Furthermore, while first toy part 11 is shown in the form of an animal (i.e., a bear), it is to be understood that first toy part 11 may be constructed in any appropriate form and is not limited to that which is shown in FIGS. 1-2.

In the embodiment shown in FIGS. 1-2, first toy part 11 is configured as a fabric and/or plush toy. However, unlike conventional fabric and/or plush pet toys, first toy part 11 includes a stuffingless cavity (not shown) formed therein which is sized and configured to at least temporarily retain a second toy part 20 of pet toy assembly 10. Accordingly, first toy part 11 acts as an exterior toy, while second toy part 20 acts as an interior toy, enabling pet toy assembly 10 to (at least initially) be formed as a two-in-one toy.

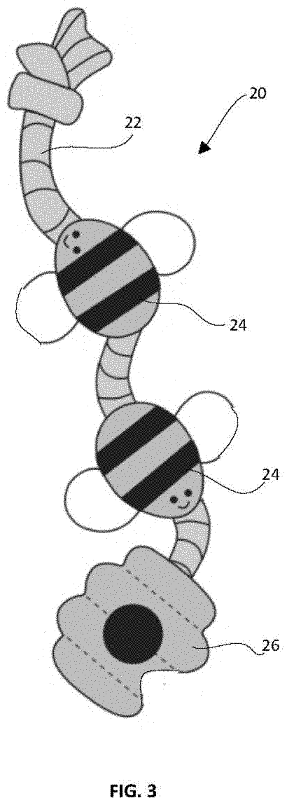

More specifically, second toy part 20 may include an elongated portion 22. In some embodiments, elongated portion 22 may be formed as a rope or cord. However, it is to be understood that elongated portion 22 may be formed of any appropriate material, such as, e.g., an elongated piece of cotton or fleece fabric, a nylon strap, etc. Referring to FIG. 3, the elongated portion 22 of second toy part 20 may have one or more secondary toy members 24, 26 coupled or affixed thereto. For example, in the embodiment shown in FIG. 3, a pair of secondary toy members 24 in the form of bees may be coupled along an intermediate portion of elongated portion 22, while another secondary toy member 26 in the form of a beehive may be coupled at one end of elongated portion 22. In this way, second toy part 20 of pet toy assembly 10 is thematically consistent with first toy part 11 of pet toy assembly 10 (i.e., a beehive and bees hypothetically eaten by a bear). However, such consistency in theme between various parts of pet toy assembly 10 is not necessary, and first toy part 11 and second toy part 20 need not be interrelated.

As noted above, secondary toy members 24, 26 are coupled to elongated portion 22 so as to form a second toy part 20 completely separate from first toy part 11. The secondary toy members 24, 26 can be formed of any appropriate material. For example, in one embodiment, one or more of secondary toy members 24, 26 may be formed as a plush or fabric material. Additionally and/or alternatively, the secondary toy members 24, 26 may be formed of one or more of, e.g., a TPR material, a vinyl material, a consumable material (e.g., rawhide, chewable treat, etc.), or any other appropriate material. Furthermore, while three secondary toy members 24, 26 are shown in FIG. 3, it is to be understood that more or fewer secondary toy members may be utilized.

Referring again to FIGS. 1-2, one end region of elongated portion 22 is configured to extend a certain distance from an opening 18 formed in first toy part 11 such that at least prior to initial use of the pet toy assembly 10, only that end region of elongated portion 22 is initially visible from the outside of the pet toy assembly 10. In some embodiments, the end region may extend out of the opening 18 a distance of, e.g., 3-5 inches. However, it is to be understood that the end region of elongated portion 22 may extend less than or greater than this distance. Additionally and/or alternatively, the end region may be configured (e.g., colored, sized, textured, etc.) in relation to the first toy part 11. For example, as first toy part 11 is in the form of an animal (i.e., a bear), at least the end region of elongated portion 22 may be designed to look like, e.g., an animal's tongue extending from the opening 18, which itself may be configured to appear as the animal's mouth. However, it is to be understood that the opening 18 may be formed anywhere along first toy part 11, and that more than one opening 18 may be present.

As is shown in FIG. 2, the opening 18 may include an elastic border 17, which may allow the elongated portion 22 to be held, at least temporarily, within the opening 18 such that the second toy part 20 substantially remains within the first toy part 11 prior to use. Upon purchase of the pet toy assembly 10, the second toy part 20 is almost entirely held within the cavity formed within first toy part 11, with the exception of the end region of elongated portion 22 extending from opening 18. Thus, a user's first impression of pet toy assembly 10 is that it is a single, unitary toy. However, once used by a pet, the second toy part 20 may be pulled through the opening 18 by way of the elongated portion 22, revealing the one or more secondary toy members 24, 26. In this way, pet toy assembly 10 provides for greater surprise and delight over conventional pet toys, as what appears to be a single toy is, in actuality, two separate toys, each of which may have very different qualities (plush, rope toy, consumable toy, etc.).

In some embodiments, the second toy part 20 is completely separate from first toy part 11, and once the second toy part 20 is pulled through the opening 18, it cannot be reinserted into the cavity formed within first toy part 11. Thus, in such a configuration, the surprise element of the secondary toy(s) is only provided upon first use of the pet toy assembly 10. However, it is to be understood that in other embodiments, the second toy part 20 and the first toy part 11 may be configured such that the second toy part 20 (and/or other toy members) may be manually reinserted back into the first toy part 11 subsequent to the initial use. Additionally and/or alternatively, while pet toy assembly 10 is shown as having the first toy part 11 and the second toy part 20 as entirely distinct objects, in some embodiments, a second end of elongated portion 22 (i.e., the end not protruding from opening 18) may be coupled to some portion of the first toy part 11 such that the second toy part 20 may be pulled from opening 18 to expose the secondary toys, but the second toy part 20 is not entirely separated from the first toy part 11.

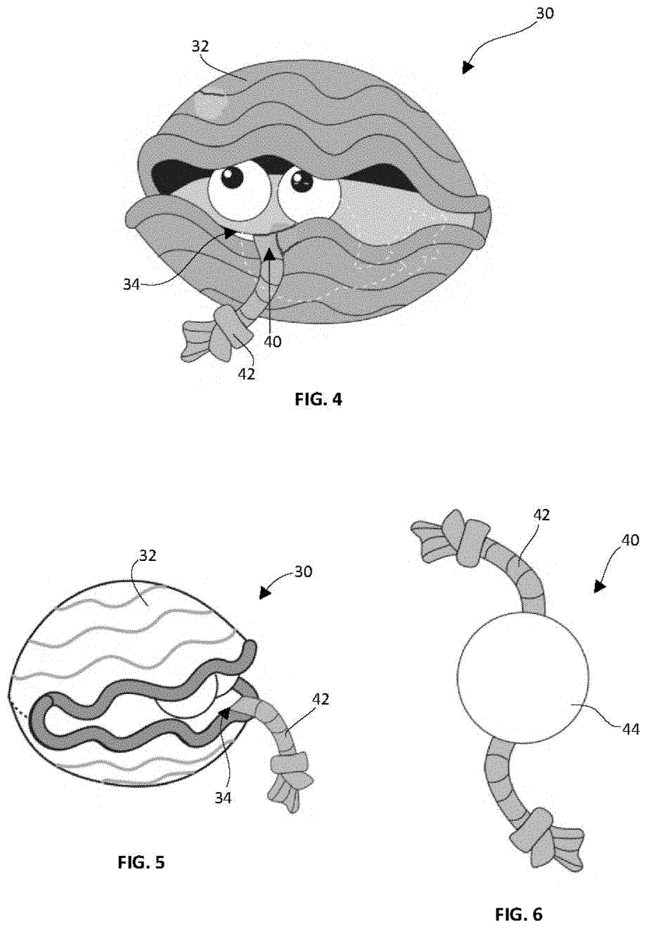

Next, referring to FIGS. 4-6, a pet toy assembly 30 in accordance with another aspect of the disclosure is shown. While the pet toy member 10 described above with respect to FIGS. 1-3 pertained to a bear plush, the pet toy assembly 30 is in the form of an oyster or clam shell. The pet toy assembly 30 may include a first exterior part 32 along with a second interior part 40. As shown in FIGS. 4-6, the first exterior part 32 may resemble a shell, and may be formed of any appropriate material such as, e.g., plush fabric, TPR, vinyl, etc. As with the pet toy member 10 described above, the first exterior part 32 may include a cavity formed therein, wherein the cavity is sized and configured to at least partially retain the second interior part 40, albeit temporarily.

As shown in FIGS. 4-5, the first exterior part 32 may have an opening 34 formed therein, through which one end region of an elongated portion 42 of the second interior part 40 may extend prior to initial use of the pet toy assembly 30. While not shown, the opening 34 may include an elastic portion to aid in the retention of the elongated portion 42. Once again, the elongated portion 42 may be formed as a rope or, alternatively, any other appropriate material, such as, e.g., an elongated piece of cotton or fleece fabric, a nylon strap, etc.

Upon first use of the pet toy assembly 30, the pet may pull upon the exposed end of elongated portion 42 to release the entire second interior part 40 from the cavity within the first exterior part 32, thereby providing two separate toys formed by the first exterior part 32 and the second interior part 40, respectively. As shown in FIG. 6, the second interior part 40 may be formed substantially as a rope toy, with a ball portion 44 coupled to an elongated portion 42. In conjunction with the oyster theme of the first exterior part 32, the ball portion 44 could be considered to represent a pearl, for example. However, it is to be understood that ball portion 44 could be any appropriate toy such as, e.g., stuffing-filled plush toys of many different shapes and sizes, thermoplastic rubber (TPR) toys, consumables (e.g., chew toys, rawhide), etc. Additionally, while only one ball portion 44 is shown, it is to be understood that second interior part 40 may include more than one secondary toy coupled thereto.

Additionally, while in some embodiments the first exterior part 32 and the second interior part 40 are configured to be completely separate once the second interior part 40 is pulled from the cavity within the first exterior part and not be reinserted into the cavity, it is to be understood that in other embodiments, the first exterior part 32 and the second interior part 40 may be configured such that the second interior part 40 may be manually reinserted back into the first exterior part 32 subsequent to the initial use. Additionally and/or alternatively, while the pet toy assembly 30 is shown as having the first exterior part 32 and the second interior part 40 as entirely distinct objects, in some embodiments, a second end of the elongated portion 42 (i.e., the end not protruding from an opening) may be coupled to some portion of the first exterior part 32 such that the second interior part 40 may be pulled from an opening to expose the secondary toys, but the second interior part 40 is not entirely separated from the first exterior part 32.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A pet toy assembly comprising:
a first toy part, the first toy part including a cavity formed therein; and
a second toy part separate from the first toy part,
the second toy part being at least partially retained within the cavity of the first toy part prior to use of the pet toy assembly, and
at least a portion of the second toy part extending from the first toy part prior to use of the pet toy assembly.

2. The pet toy assembly of claim 1, further comprising an elongated portion of the second toy part having first and second end regions and at least one secondary toy coupled to the elongated portion.

3. The pet toy assembly of claim 2, wherein one of the first end region and the second end region of the elongated portion extends from an opening formed in the first toy part.

4. The pet toy assembly of claim 3, wherein the opening includes an elastic border to aid in the retention of the elongated portion of the second toy part.

5. The pet toy assembly of claim 3, wherein one of the first end region and the second end regain extends from the opening a distance of 3 inches to 5 inches.

6. The pet toy assembly of claim 2, wherein the elongated portion is a rope.

7. The pet toy assembly of claim 2, wherein the at least one secondary toy is at least one of a ball-shaped toy, a stuffing-filled plush toy, a thermoplastic rubber (TPR) toy, a vinyl toy, and a consumable pet treat.

8. The pet toy assembly of claim 1, wherein the first toy part is a formed as a plush fabric toy.

9. A pet toy assembly comprising:
an exterior toy part including a cavity formed therein; and
an interior toy part having an elongated portion and at least one secondary toy coupled thereto,
the interior toy part being separate from the exterior toy part and partially and temporarily retained within the cavity of the exterior toy part, and
an end portion of the elongated portion of the interior toy part extends from the exterior toy part.

10. The pet toy assembly of claim 9, wherein the end portion of the elongated portion extends from an opening formed in the exterior toy part.

11. The pet toy assembly of claim 10, wherein the opening includes an elastic border to aid in the retention of the elongated portion of the interior toy part.

12. The pet toy assembly of 10, wherein the end portion of elongated portion extends from the opening a distance of 3 inches to 5 inches.

13. The pet toy assembly of claim 9, wherein the elongated portion is a rope.

14. The pet toy assembly of claim 9, wherein the at least one secondary toy is at least one of a ball-shaped toy, a stuffing-filled plush toy, a thermoplastic rubber (TPR) toy, a vinyl toy, and a consumable pet treat.

15. A method of forming a two-in-one pet toy assembly, the method comprising:
providing an exterior toy part;
forming a cavity within the exterior toy part;
forming at least one opening upon the exterior toy part, wherein the at least one opening communicates with the cavity;
providing an interior toy part separate from the exterior toy part, the interior toy part having an elongated portion including an end region and at least one secondary toy coupled to the elongated portion, and
inserting a portion of the interior toy part into the cavity of the exterior toy part such that the at least one secondary toy coupled to the interior toy part is temporarily retained within the cavity and the end region of the elongated portion extends from the opening of the exterior toy part.

16. The method of claim 15, further comprising providing an elastic border around the opening of the exterior toy part.

17. The method of claim 15, wherein the elongated portion is formed as a rope.

18. The method of claim 15, wherein the at least one secondary toy is at least one of a ball-shaped toy, a stuffing-filled plush toy, a thermoplastic rubber (TPR) toy, a vinyl toy, and a consumable pet treat.
